(19) United States
(12) Patent Application Publication
(10) Pub. No.: US 2009/0254397 A1
(43) Pub. Date: Oct. 8, 2009

(54) SYSTEM AND METHOD FOR OPTIMIZING ONLINE KEYWORD AUCTIONS SUBJECT TO BUDGET AND ESTIMATED QUERY VOLUME CONSTRAINTS

(75) Inventors: Mohammad Mahdian, Santa Clara, CA (US); Hamid Nazerzadeh, Stanford, CA (US)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/099,055

(22) Filed: Apr. 7, 2008

(51) Int. Cl. G06Q 30/00; G06Q 10/00; G06F 17/30

(52) U.S. Cl. 705/8; 705/10; 705/14; 705/7

(57) ABSTRACT

An improved system and method for optimizing online keyword auctions subject to budget and estimated query volume constraints is provided. A linear programming model of slates of advertisements may be created using estimates of the query volume for multiple time periods for use in generating a slate of advertisements that may represent a candidate set of advertisements in order of optimal revenue to an auctioneer. Upon receiving a query request, the slate generated by the linear program or a slate generated by dynamic programming may be chosen based on whether the weighted sum of prices for the slate of advertisements computed by dynamic programming may be within a factor of the weighted sum of the prices for the slate of advertisements computed by the linear program. The chosen slate of advertisements may then be served to accompany the search results of a query request to the web browser.

### FIELD OF THE INVENTION

The invention relates generally to computer systems, and more particularly to an improved system and method for optimizing online keyword auctions subject to budget and estimated query volume constraints.

### BACKGROUND OF THE INVENTION

A major problem faced by an online advertising publisher is to decide how to allocate advertisement space to advertisers in real-time. This problem is complicated by the fact that many advertisers are constrained by their budget, and also by the fact that the total volume of available advertisement space in a given day is unknown ahead of the time. Such is the case for query volumes in sponsored search advertising for instance.

One method for solving this problem is to use the historical data such as bids and query volumes from previous days to obtain an estimate for the volume of available advertising space, and then based on this data, solve a linear program (LP) to allocate advertisement space to advertisers optimally. If the predicted advertising space volume is accurate, this algorithm yields an approximately optimal allocation. However, often the estimates are slightly inaccurate, and this can lead to a few percentage points decrease in the revenue compared to the optimal allocation.

Competitive analysis for evaluating the performance of an online algorithm has been applied to online keyword auctions by Mehta for optimally allocating online advertisement space to budget-constrained advertisers. See Aranyak Mehta, Amin Saberi, Umesh Vazirani, and Vijay Vazirani, Adwords and Generalized On-line Matching, In Proceedings of the 46th Annual IEEE Symposium on Foundations of Computer Science, pages 264-273, 2005. Mehta developed an algorithm with a competitive ratio of 1-1/e where at most one advertisement may be shown for each query. Mehta showed that this is the best possible ratio an online algorithm can achieve in a worst-case analysis where the query volume may be unknown beforehand. Unfortunately, the approach of worst-case analysis for online algorithms favors algorithms that make extremely conservative choices.

What is needed is a way for allocating online advertisement space that reduces the loss when estimates of query volumes are inaccurate. Such a system and method should perform well in the case that the estimates are accurate as well as when the estimates are inaccurate. Moreover, the system and method should be applicable for displaying multiple advertisements for each query and for payments based on a generalized second price auction.

### SUMMARY OF THE INVENTION

Briefly, the present invention may provide a system and method for optimizing online keyword auctions subject to budget and estimated query volume constraints. In various embodiments, a client having a web browser may be operably coupled to a query processing server for sending a query request. The query processing server may include a query forecasting engine for predicting the query volume during multiple time periods of a time span and a model generator for creating a linear programming model using the predicted query volumes to provide a candidate set of advertisements for keywords of query requests for multiple time periods. The query processing server may also include an operably coupled linear programming analysis engine for optimizing the linear programming model offline to generate slates of advertisements for keywords of a query request for multiple time periods and to generate a frequency for each slate to indicate how often the slate of advertisements should be displayed. The query processing server may additionally include a dynamic programming engine for determining a slate of advertisements for a keyword of a query request that may maximize a weighted sum of the prices in order to compute a near optimal solution when the estimates of query volume are inaccurate. The query processing server may also include a competitive analysis engine for choosing either the slate generated by the linear program or the slate generated by dynamic programming based on whether the weighted sum of prices for the slate of advertisements computed by dynamic programming may be within a factor of the weighted sum of the prices for the slate of advertisements computed by the linear program. The query processing server may then serve the chosen slate of advertisements to accompany the search results of a query request to the web browser.

In an embodiment to compute a near optimal slate of advertisements in the event the estimates of query volume are inaccurate, dynamic programming may be applied to recursively determine a slate of advertisements that may maximize the sum of revenue for allocating advertisements to multiple web page placements calculated for a generalized second price auction using a parameterized discount factor for each bid based on a budget spent by an advertiser. First, advertisers may be sorted in decreasing order by expected value. The maximum value of revenue may then be computed for each advertiser for a generalized second price auction using a parameterized discount factor for each bid based on the budget spent by the advertiser. A slate of advertisements may be constructed in decreasing order by maximum value of revenue computed for each advertiser, and the slate of advertisements may be output.

Advantageously, the present invention may effectively use a forecast of the frequency and sequence of keywords to compute a slate of advertisements and may also compute a near optimal slate of advertisements to use in the event estimates of query volume are inaccurate. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for optimizing online keyword auctions subject to budget and estimated query volume constraints, in accordance with an aspect of the present invention;

FIG. 3 is a flowchart for generally representing the steps undertaken in one embodiment for maximizing revenue in an online keyword auction with budget constraints by choosing a slate of advertisements generated by a linear program when estimates of query volumes are accurate and choosing a slate of advertisements generated by dynamic programming when estimates of query volumes are inaccurate, in accordance with an aspect of the present invention; and

FIG. 4 is a flowchart for generally representing the steps undertaken in one embodiment for selecting a slate of advertisements for a keyword in a time period that maximizes revenue for a generalized second price auction using a parameterized discount factor for each bid based on a budget spent by an advertiser.

### DETAILED DESCRIPTION

### Exemplary Operating Environment

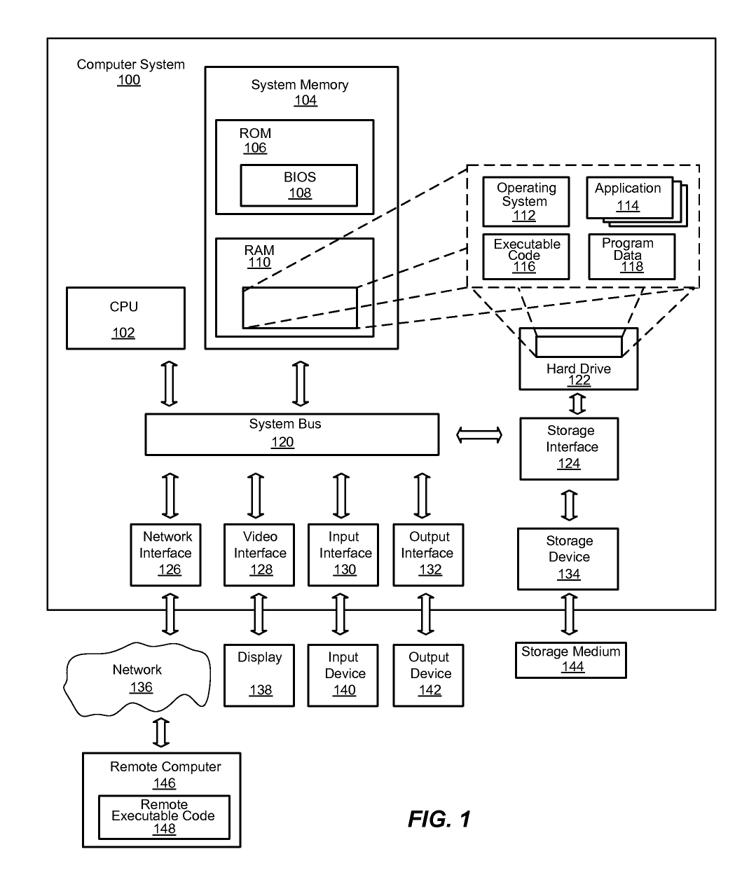

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Optimizing Online Keyword Auctions Subject to Budget and Estimated Query Volume Constraints

The present invention is generally directed towards a system and method for optimizing online keyword auctions subject to budget and estimated query volume constraints. A linear programming model of slates of advertisements may be created offline for predicting the frequency and sequence of keywords occurring for multiple time periods throughout a time span for use in online scheduling of bidders to auctions that may optimize revenue of an auctioneer. Each slate of advertisements may represent a candidate set of advertisements in order of optimal revenue to an auctioneer. Upon receiving a query request, a slate of advertisements may be chosen online according to the generated frequencies. To improve the solution provided by the linear program, a slate of advertisements may be selected online that may maximize a weighted sum of the prices in order to compute a near optimal solution when the estimates of query volume are inaccurate. Then one of these two slates may be chosen based on whether the weighted sum of prices for the second slate may be within a factor of the weighted sum of the prices for the first slate provided by the linear program. And the chosen slate of advertisements may then be output for sending to a web browser for display.

As will be seen, dynamic programming may be applied to compute a near optimal slate of advertisements to hedge against inaccurate estimates of query volume used by the linear program. As will be understood, the various block diagrams, flow charts and scenarios described herein are only examples, and there are many other scenarios to which the present invention will apply.

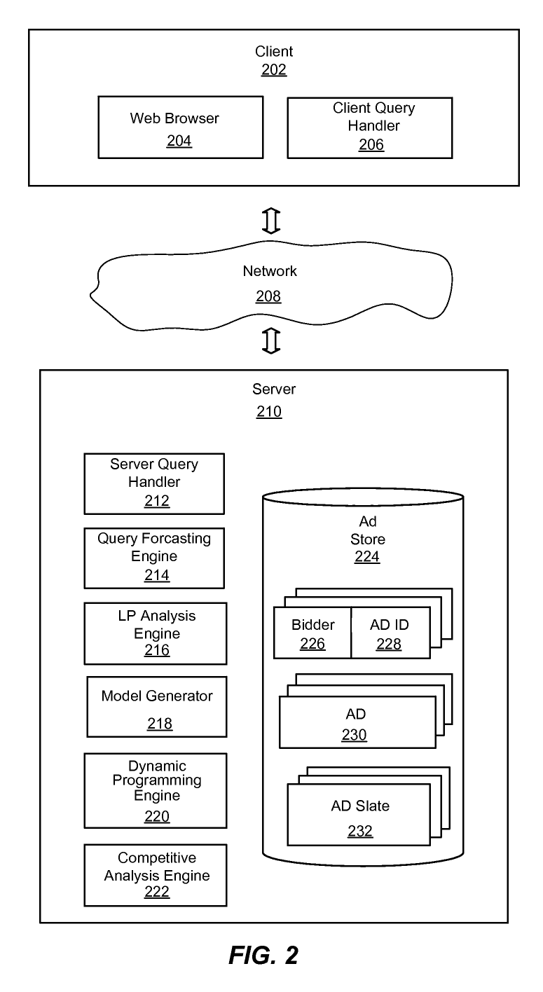

Turning to FIG. 2 of the drawings, there is shown a block diagram generally representing an exemplary architecture of system components for optimizing online keyword auctions subject to budget and estimated query volume constraints. Those skilled in the art will appreciate that the functionality implemented within the blocks illustrated in the diagram may be implemented as separate components or the functionality of several or all of the blocks may be implemented within a single component. For example, the functionality for the client query handler 206 may be included in the same component as the web browser 204. Or the functionality of the model generator 218 may be implemented as a separate component on another server. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 210 by a network 208. The client computer 202 may be a computer such as computer system 100 of FIG. 1. The network 208 may be any type of network such as a local area network (LAN), a wide area network (WAN), or other type of network. A web browser 204 may execute on the client computer 202 and may include functionality for receiving a search request which may be input by a user entering a query. The web browser 204 may be operably coupled to a client query handler 206 that may include functionality for receiving a query entered by a user and for sending a query request to a server to obtain a list of search results. In general, the web browser 204 and the client query handler 206 may be any type of interpreted or executable software code such as a kernel component, an application program, a script, a linked library, an object with methods, and so forth.

The server 210 may be any type of computer system or computing device such as computer system 100 of FIG. 1. In general, the server 210 may provide services for query processing and may include services for providing a list of auctioned advertisements to accompany the search results of query processing. In particular, the server 210 may include a server query handler 212 for receiving and responding to query requests, a query forecasting engine 214 for predicting the query volume during multiple time periods of a time span, a model generator 218 for creating a linear programming model used to provide a candidate set of advertisements for keywords of query requests for multiple time periods, a linear program analysis engine, or optimizer, 216 for choosing slates of advertisements for keywords of the queries expected for processing for multiple time periods, a dynamic programming engine 220 for computing a near optimal slate of advertisements to hedge against inaccurate estimates of query volume, and a competitive analysis engine 222 for choosing slates of advertisements generated by the linear program and by dynamic programming. Each of these modules may also be any type of executable software code such as a kernel component, an application program, a linked library, an object with methods, or other type of executable software code.

The server 210 may be operably coupled to a database of advertisements such as advertisement store 224 that may include any type of advertisements 230 that may be associated with an advertisement ID 228. In an embodiment, several bidders 226 may be associated with an advertisement ID 228 for one or more advertisements 230. The advertisement store 224 may also include a collection of advertisement slates 232 that may be generated as part of the linear programming model, each advertisement slate representing an ordered candidate set of advertisements for keywords of a query request.

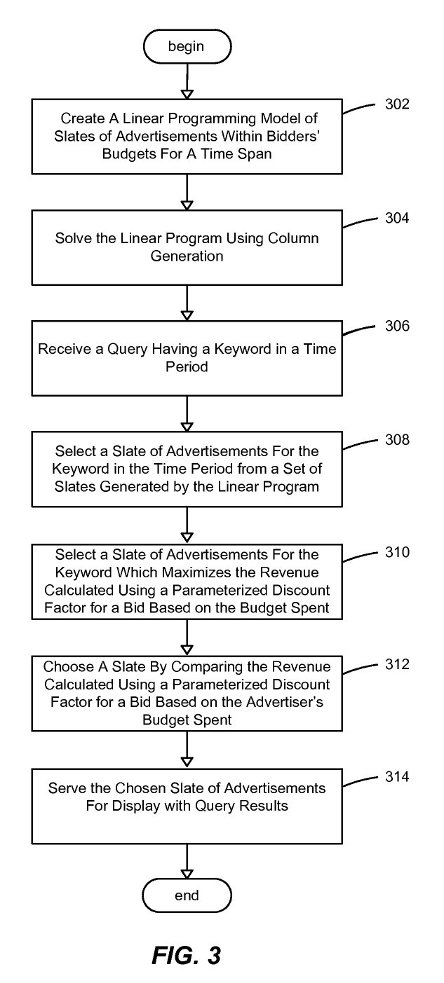

FIG. 3 presents a flowchart for generally representing the steps undertaken in one embodiment for maximizing revenue in an online keyword auction with budget constraints by choosing a slate of advertisements generated by a linear program when estimates of query volumes are accurate and choosing a slate of advertisements generated by dynamic programming using a parameterized discount factor for each bid based on a budget spent by an advertiser when estimates of query volumes are inaccurate. In an embodiment, consider M={Θ, B} to be an auction marketplace, where Θ={q₁, q₂, . . . , q_{N}} may be a set of possible queries and B={b₁, b₂, . . . , b_{M}} may be a set of all bidders. Also consider the “bidding state” of the auction marketplace to be defined for multiple time periods, t={1, . . . , T}, by a matrix A^{t}, where A^{t}_{i,j} may be the bid amount that the j-th bidder may be bidding on the i-th query qᵢ for time period t. Assuming a static bidding state (A^{t}=A), consider the daily budget limit that may be specified by each bidder bⱼ to be defined as dⱼ. Note that in an embodiment, dⱼ can represent the daily budget for a campaign, where a buyer may be associated with multiple campaigns. Thus dⱼ may represent a daily spend limit by a bidder (or campaign) across multiple queries. If a daily budget limit may not be specified for a bidder, then assume that dⱼ=∞.

For each query qᵢ, consider R_{i,j}^{t}=A_{i,j}^{t}·Q_{i,j}^{t} to be the ranking function used to rank the j-th offer in an auction instance, where Q_{i,j}^{t} may be generally a time-dependent weighting factor, or “quality score” for the i-th query and j-th bidder for time period t. The ranking function R_{i,j}^{t} may be equal to zero for any bidder bⱼ that may not participate in an auction instance. For a keyword i in time period t, consider T_{i,j}_{ₚ}^{t} to denote the expected click-through-rate (“CTR”) for a bidder j who may be ranked at slot p on a page. In an embodiment, a search engine may charge advertisers based on the generalized second price where an advertisement of advertiser j appears in slot p for keyword i. Advertiser j would pay

$${T}_{i , {j}_{p}}^{t} \cdot {A}_{i , {j}_{p + 1}}^{t} \cdot \frac{{Q}_{i , {j}_{p + 1}}^{t}}{{Q}_{i , {j}_{p}}^{t}} .$$

A linear programming model may be created for this defined marketplace by estimating query volumes.

Using the method described in related copending U.S. patent application Ser. No. 11/497,085, entitled “SYSTEM AND METHOD FOR SCHEDULING ONLINE KEYWORD AUCTIONS SUBJECT TO BUDGET CONSTRAINTS,” assigned to the assignee of the present invention, a linear programming model of slates of advertisements within bidders' budgets may be created at step 302 for a time span and the linear program may be solved at step 304 using column generation. At step 306, a query having a keyword may be received in a time period, and a slate of advertisements for the keyword in the time period may be selected at step 308 from a set of slates generated by the linear program in an embodiment using the method described in related copending U.S. patent application Ser. No. 11/497,085, entitled “SYSTEM AND METHOD FOR SCHEDULING ONLINE KEYWORD AUCTIONS SUBJECT TO BUDGET CONSTRAINTS,” assigned to the assignee of the present invention.

To improve upon the solution provided by the linear program in the event that the estimates of query volumes are inaccurate, a slate of advertisements for the keyword in the time period may be selected at step 310 by dynamic programming using a parameterized discount factor for each bid based on a budget spent by an advertiser. In an embodiment, the search engine may rank the advertisements in a slate according to R_{i,j}^{t}=A_{i,j}^{t}·Q_{i,j}^{t}. For a keyword i in time period t, consider T_{i,j}_{ₚ}^{t} to denote the expected click-through-rate (“CTR”) for a bidder j who may be ranked at slot p on a page. The search engine may charge advertisers based on the generalized second price where an advertisement of advertiser j appears in slot p for keyword i. Thus, advertiser j would pay

$${T}_{i , {j}_{p}}^{t} \cdot {A}_{i , {j}_{p + 1}}^{t} \cdot \frac{{Q}_{i , {j}_{p + 1}}^{t}}{{Q}_{i , {j}_{p}}^{t}} .$$

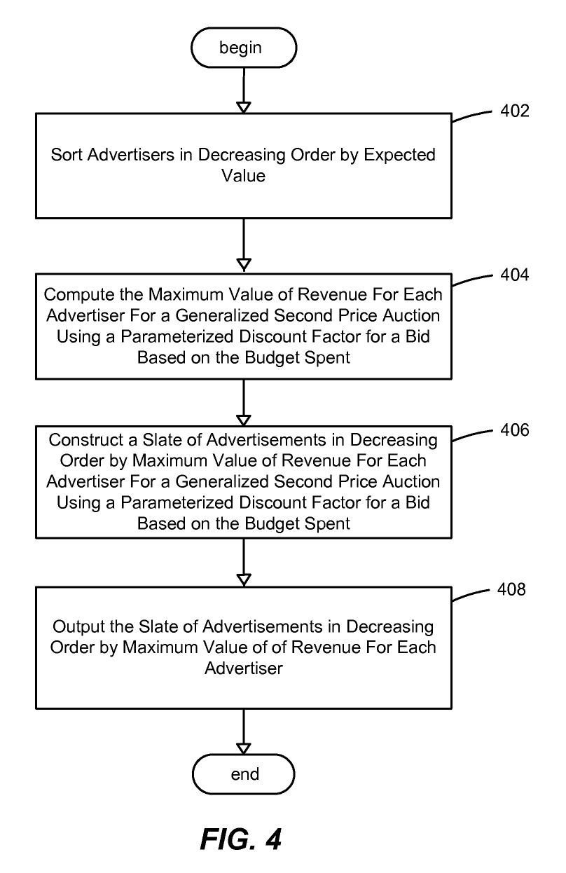

In applying dynamic programming to recursively determine a slate of advertisements that may maximize the sum of revenue for allocating advertisements to multiple web page placements in a generalized second price auction, a parameterized discount factor may be used for each bid based on a budget spent by an advertiser. The function φ_{α}(x)=1−e^{α·(x-1)} may be defined to calculate a parameterized discount factor for each bid based on a budget spent by an advertiser. Let ƒⱼ be the fraction of the budget spent for advertiser j. Consider slate k for keyword i where the ordering of the advertisers in this slate is 1, . . . , m. Then Φ_{α}(k) may be defined as:

$${Φ}_{α} ( k ) = {\sum }_{j = 1}^{m - 1} φ ( {f}_{j} ) \cdot {T}_{i , {j}_{p}}^{t} \cdot {A}_{i , {j}_{p + 1}}^{t} \cdot \frac{{Q}_{i , {j}_{p + 1}}^{t}}{{Q}_{i , {j}_{p}}^{t}} ,$$

where Φ_{α}(k) may represent the sum of revenue for allocating the slate of advertisements to multiple web page placements which is calculated for a generalized second price auction using a parameterized discount factor for each bid based on a budget spent by an advertiser. A description of the steps applying dynamic programming to recursively determine a slate of advertisements that may maximize the sum of revenue for allocating advertisements to multiple web page placements calculated for a generalized second price auction using a parameterized discount factor for each bid based on a budget spent by an advertiser may be described in more detail in conjunction with FIG. 4.

The algorithm may be fine tuned by adjusting a parameter α≧1 that may control the extent of relying on the solution provided by the linear program using estimated query volumes. If α=1, then the algorithm may ignore the solution provided by the linear program using estimated query volumes and will use the solution provided by dynamic programming which will have the same performance as the competitive ratio of (1-1/e). If α=∞, the algorithm will ignore the solution provided by dynamic programming and use the solution provided by the linear program. In an embodiment, α may be set based on the relative accuracy of the estimates of query volume over time.

At step 312, one of the two slates may be chosen by comparing revenue for each one of the slates of advertisements calculated using a parameterized discount factor for a bid based on a budget spent by an advertiser. Accordingly, consider S₁ to denote the slate of advertisements selected at step 308 by the linear program and consider S2 to denote the slate of advertisements selected at step 310 by dynamic programming using a parameterized discount factor for each bid based on a budget spent by an advertiser for the dynamic programming solution. If αΦ_{α}(S₁)≧Φ_{α}(S2), then the slate of advertisements S₁ may be chosen; otherwise, the slate of advertisements S₂ may be chosen. And the chosen slate of advertisements may then be served at step 314, for instance, to a web browser for display with query results.

FIG. 4 presents a flowchart for generally representing the steps undertaken in one embodiment for selecting a slate of advertisements for a keyword in a time period that maximizes revenue for a generalized second price auction using a parameterized discount factor for each bid based on a budget spent by an advertiser. In an embodiment, dynamic programming may be applied to recursively determine a slate of advertisements that may maximize the sum of revenue for allocating advertisements to multiple web page placements calculated for a generalized second price auction using a parameterized discount factor for each bid based on a budget spent by an advertiser. First, advertisers may be sorted in decreasing order by expected value at step 402. For example, the advertisers may be sorted in decreasing order of the product of their bid and their quality score.

At step 404, the maximum value of revenue may be computed for each advertiser for a generalized second price auction using a parameterized discount factor for each bid based on the budget spent by the advertiser. Assume the advertisers may be numbered in such a way that advertiser number 1 has the highest bid times quality score, then advertiser number 2, and so on, until advertiser number j, which has the lower value of the product of a bid and a quality score. An j by p matrix M may be defined where j is the number of advertisers, and p is the number of slots. The value of M(j,p) may be defined as the maximum value of the function φ_{α(ƒ}ⱼ) restricted to the first p slots, assuming that advertiser j is placed in the p+1 slot. The following recurrence relation may be used in an embodiment to compute the entries of matrix M:

$$M ( j , p ) = {max}_{r = 1}^{j - 1} M ( r , p - 1 ) + {φ}_{α} ( {f}_{r} ) \cdot {T}_{i , {r}_{p}} \cdot {A}_{i , {j}_{p + 1}} \cdot \frac{{Q}_{i , {j}_{p + 1}}}{{Q}_{i , {r}_{p}}} .$$

Note that by using the above recurrence, all of the entries of the matrix M may be computed, starting from the first column and proceeding column by column to the right. Intuitively, the above recurrence tries all possible advertisers for slot p, and for each choice, computes the value of φ_{α}(ƒⱼ) using a previously-computed entry in the matrix, and it then chooses the advertiser that gives the maximum value for the function φ_{α}(ƒⱼ).

Accordingly, a slate of advertisements may be constructed at step 406 in decreasing order by maximum value of revenue computed for each advertiser for a generalized second price auction using a parameterized discount factor for each bid based on the budget spent by the advertiser, and the slate of advertisements may be output at step 408.

Although estimates of query volume may often be accurate, occasionally the estimates may be inaccurate due to unexpected events. In response to the occurrence of an event in the world, there may be a surge in the frequency of search terms. Any such increase in query volumes of a search term may be valuable for advertisers but are extremely difficult to predict. Thus, the present invention may provide a considerably better competitive ratio for an optimal allocation of advertisements in keyword auctions if the future events are actually close to the estimates, while still maintaining a reasonable competitive ratio if an unpredicted event changes the sequence of events drastically.

As can be seen from the foregoing detailed description, the present invention provides an improved system and method for optimizing online keyword auctions subject to budget and estimated query volume constraints. Such a system and method may effectively use a forecast of the frequency and sequence of keywords to compute a slate of advertisements and may also compute a near optimal slate of advertisements to use in the event estimates of query volume are inaccurate. Upon receiving a query request, the slate generated by the linear program or the slate generated by dynamic programming may be chosen based on whether the weighted sum of prices for the slate of advertisements computed by dynamic programming may be within a factor of the weighted sum of the prices for the slate of advertisements computed by the linear program. This may increase revenue when unexpected changes in query volume occur. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for scheduling online advertisements, comprising:
a linear programming analysis engine for determining an optimal slate of advertisements for at least one keyword of a query request being processed;
a dynamic programming engine for determining a slate of advertisements for the at least one keyword of the query request that maximizes revenue for a generalized second price auction using a parameterized discount factor for a bid based on a budget spent by an advertiser; and
a competitive analysis engine operably coupled to the linear programming analysis engine and the dynamic programming engine for choosing one of the slates of advertisements by comparing revenue for each one of the slates of advertisements calculated using a parameterized discount factor for a bid based on a budget spent by an advertiser.

2. The system of claim 1 further comprising a query processing server operably coupled to the competitive analysis engine for providing slates of auctioned advertisements accompanying search results of query processing.

3. The system of claim 1 further comprising a query forecasting engine operably coupled to the linear programming analysis engine for predicting a query volume for a plurality of time periods of a time span.

4. A computer-readable medium having computer-executable components comprising the system of claim 1.

5. A computer-implemented method for scheduling online auctions, comprising:
receiving a query having a keyword in a time period;
determining a first slate of advertisements for the keyword in the time period from a plurality of slates of advertisements generated by a linear programming model;
determining a second slate of advertisements for the keyword in the time period that maximizes revenue for a generalized second price auction using a parameterized discount factor for each bid based on a budget spent by an advertiser;
choosing one of the first slate of advertisements and the second slate of advertisements by comparing revenue for each one of the slates of advertisements calculated using a parameterized discount factor for a bid based on a budget spent by an advertiser; and
outputting the chosen slate of advertisements for display with the results of the query.

6. The method of claim 5 further comprising creating the linear programming model of slates of advertisements for each of the plurality of time periods.

7. The method of claim 5 wherein determining a slate of advertisements for the keyword in the time period from a plurality of slates of advertisements generated by a linear programming model comprises finding slates of advertisements for the keyword for the time period and frequencies for displaying each slate of advertisements, each slate representing a candidate set of advertisements generated by the linear programming model of slates of advertisements for each of a plurality of time periods.

8. The method of claim 5 wherein creating the linear programming model of slates of advertisements for each of the plurality of time periods comprises obtaining an estimate of the number of queries for each of the plurality of time periods.

9. The method of claim 5 wherein determining the second slate of advertisements for the keyword in the time period that maximizes revenue for the generalized second price auction using the parameterized discount factor for each bid based on the budget spent by the advertiser comprises sorting a plurality of advertisers in decreasing order by expected value.

10. The method of claim 5 wherein determining the second slate of advertisements for the keyword in the time period that maximizes revenue for the generalized second price auction using the parameterized discount factor for each bid based on the budget spent by the advertiser comprises computing the maximum value of revenue for each advertiser for the generalized second price auction using the parameterized discount factor for each bid based on the budget spent by each advertiser.

11. The method of claim 5 wherein determining the second slate of advertisements for the keyword in the time period that maximizes revenue for the generalized second price auction using the parameterized discount factor for each bid based on the budget spent by the advertiser comprises constructing a slate of advertisements in decreasing order by the maximum value of revenue for each advertiser for the generalized second price auction using the parameterized discount factor for each bid based on the budget spent by each advertiser.

12. The method of claim 5 wherein determining the second slate of advertisements for the keyword in the time period that maximizes revenue for the generalized second price auction using the parameterized discount factor for each bid based on the budget spent by the advertiser comprises outputting a slate of advertisements in decreasing order by the maximum value of revenue for each advertiser for the generalized second price auction using the parameterized discount factor for each bid based on the budget spent by each advertiser.

13. The method of claim 5 wherein outputting the chosen slate of advertisements for display with the results of the query comprises including the slate of advertisements in a web page for display to a user.

14. The method of claim 5 wherein using a parameterized discount factor for each bid based on a budget spent by an advertiser comprises multiplying the discount factor for each bid based on a budget spent by an advertiser by a weight to control reliance on the first slate of advertisements generated by the linear programming model based upon estimates of query volumes.

15. The method of claim 5 wherein determining a second slate of advertisements for the keyword in the time period that maximizes revenue for a generalized second price auction using a parameterized discount factor for each bid based on a budget spent by an advertiser comprises applying dynamic programming to recursively determine the maximum revenue for a plurality of slates of advertisements for the generalized second price auction using the parameterized discount factor for each bid based on the budget spent by the advertiser.

16. The method of claim 5 wherein choosing one of the first slate of advertisements and the second slate of advertisements by comparing revenue for each one of the slates of advertisements calculated using a parameterized discount factor for a bid based on a budget spent by an advertiser comprises comparing the product of a parameter and the revenue of the first slate of advertisements calculated using the parameterized discount factor for each bid based on a budget spent by the advertiser with the revenue of the second slate of advertisements calculated using the parameterized discount factor for each bid based on the budget spent by the advertiser.

17. A computer-readable medium having computer-executable instructions for performing the method of claim 5.

18. A computer system for scheduling online auctions, comprising:
means for determining a first slate of advertisements for a keyword in a time period using a linear programming model;
means for determining a second slate of advertisements for the keyword in the time period that maximizes revenue for a generalized second price auction using a parameterized discount factor for each bid based on a budget spent by an advertiser;
means for choosing one of the first slate of advertisements and the second slate of advertisements by comparing revenue for each one of the slates of advertisements calculated using a parameterized discount factor for each bid based on a budget spent by an advertiser; and
means for outputting the chosen slate of advertisements for display with the results of the query.

19. The computer system of claim 18 further comprising means for obtaining an estimate of a number of queries for the time period to construct the linear programming model.

20. The computer system of claim 18 wherein means for choosing one of the first slate of advertisements and the second slate of advertisements by comparing revenue for each one of the slates of advertisements calculated using a parameterized discount factor for each bid based on a budget spent by an advertiser comprises means for comparing a product of a parameter and the revenue of the first slate of advertisements calculated using the parameterized discount factor for each bid based on a budget spent by the advertiser with the revenue of the second slate of advertisements calculated using the parameterized discount factor for each bid based on the budget spent by the advertiser.
